(19) United States
(12) Patent Application Publication
(10) Pub. No.: US 2011/0033120 A1
(43) Pub. Date: Feb. 10, 2011

(54) IMAGE PROCESSING DEVICE AND IMAGE PROCESSING METHOD

(75) Inventor: Isao SEZAKI, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/817,888

(22) Filed: Jun. 17, 2010

(30) Foreign Application Priority Data
Aug. 10, 2009 (JP) 2009-186059

(51) Int. Cl. G06K 9/54

(52) U.S. Cl. 382/203

(57) ABSTRACT

An image processing device includes a pixel value read out unit which reads out a pixel value of a target pixel, a pixel value change unit which changes a pixel value of a noticeable pixel, the noticeable pixel being at least one pixel of adjacent pixels adjacent to the target pixel, and a coordinate specify unit which specifies a position of the target pixel in an image, the target pixel having the noticeable pixel as the adjacent pixel. The pixel value of the noticeable pixel is changed.

### INCORPORATION BY REFERENCE

This application is based upon and claims the benefit of priority from Japanese patent application No. 2009-186059, filed on Aug. 10, 2009, the disclosure of which is incorporated herein in its entirety by reference.

### BACKGROUND

1. Field of the Invention

The present invention relates to an image processing device, an image processing method which can be used for a check or a test.

2. Description of Related Art

Image processing includes a filtering process for the purpose of sharpness, feathering, embossment, solarization, contour enhancement, and contour detection. When such a filtering process is performed, images before and after the image processing may be compared to test whether or not the image processing has been performed normally.

For example, Japanese patent No. 4215459 (Ebe) discloses a device which compares image data which is a test target generated by an image output device which is under development with reference image data which is generated by an existing image output device in the test process of the image output device such as a printer or a copy-machine.

The image data comparing device disclosed in Ebe compares pixel values of image data which is a test target and is generated by the image output device with pixel values of reference image data which is reference data generated by an existing image output device. The reference image data and the image data to be tested are input into the image data comparing device, and pixel vales of these two image data are compared by one dot, to detect the locations of different dots. In the comparison of the image data, a coordinate of a neighboring dot of the different dot of the reference image data and the image data to be tested is detected and a display unit colors and displays the neighboring dot by different colors depending on the distance from the different dot. The image data comparing device thus visualizes the difference between the reference image and the image to be tested instead of displaying or outputting the difference by numerical numbers.

### SUMMARY

In the meantime, when a defect analysis is performed in an image processing device, a register stores the pixel value of the specified coordinate of a display image, and a CPU (Central Processing Unit) reads out the pixel value to compare the pixel value with data before processing in some cases. However, if the CPU simply specifies the coordinate and reads out the pixel value, a user cannot know which value of a pixel in the image the specified coordinate detects. Therefore, when the pixel value of an objective position in the display image is read out, the user needs to visually recognize the objective position.

Specifically, along with an increase of the number of bits and advancement of image processing in the field which handles an image such as digital TV, BD (Blu-ray Disc) player, the need for observation of the pixel value after the image processing has been increasing.

According to an embodiment of the present invention, there is provided an image processing device including a pixel value read out unit which reads out a pixel value of a target pixel, a pixel value change unit which changes the pixel value of the target pixel, and a coordinate specify unit which specifies a position of the target pixel in an image. The pixel value of the target pixel is changed.

According to the present invention, by changing the pixel value of the target pixel, a pixel position of the target pixel in the image can be recognized by a user, and then an objective position can be visually searched.

According to another embodiment of the present invention, there is provided an image processing device including a pixel value read out unit which reads out a pixel value of a target pixel, a pixel value change unit which changes a pixel value of a noticeable pixel, the noticeable pixel being at least one pixel of adjacent pixels adjacent to the target pixel, and a coordinate specify unit which specifies a position of the target pixel in an image, the target pixel being adjacent to the noticeable pixel included in the adjacent pixels. The pixel value of the noticeable pixel is changed.

According to the present invention, since the pixel value of the noticeable pixel adjacent to the target pixel is changed, the noticeable pixel whose pixel value has been changed can be visually recognized. This enables to visually search an objective position in the image.

According to an embodiment of the present invention, there is provided an image processing method including reading out a pixel value of a target pixel, changing the pixel value of the target pixel, and specifying a position of the target pixel in an image and checking the position of the target pixel in the image, to acquire the pixel value of the target pixel in an objective position by. The pixel value of the target pixel is changed.

According to another embodiment of the present invention, there is provided an image processing method including reading out a pixel value of a target pixel, changing a pixel value of a noticeable pixel, the noticeable pixel being at least one pixel of adjacent pixels adjacent to the target pixel, and specifying a position of the target pixel in an image and checking a position of the noticeable pixel in the image, to acquire the pixel value of the target pixel in an objective position. The target pixel is adjacent to the noticeable pixel included in the adjacent pixel. The pixel value of the noticeable pixel is changed.

According to the present invention, an image processing device and an image processing method which acquire the pixel value of the pixel of an objective position in an image are provided.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a view showing an image processing device of a first exemplary embodiment of the present invention;

FIG. 2 is an explanation view showing a method of changing a pixel value;

FIG. 3 is a circuit diagram showing the image processing device in more detail of the first exemplary embodiment of the present invention;

FIG. 4 is a view showing a target pixel and a noticeable pixel of a second exemplary embodiment of the present invention;

FIG. 5 is a circuit diagram showing an image processing device in detail of the second exemplary embodiment of the present invention;

FIG. 6 is a view showing a target pixel and noticeable pixels of a third exemplary embodiment of the present invention;

FIG. 7 is a circuit diagram showing an image processing device in detail of the third exemplary embodiment of the present invention;

FIG. 8 is a view showing a target pixel and noticeable pixels of a fourth exemplary embodiment of the present invention; and

FIG. 9 is a circuit diagram showing an image processing device in detail of the forth exemplary embodiment of the present invention.

### DETAILED DESCRIPTION OF THE EXEMPLARY EMBODIMENTS

Hereinafter, exemplary embodiments of the present invention are described in detail with reference to the accompanying drawings. In these exemplary embodiments, the present invention is applied to an image quality controlling circuit which is mounted on an image display device such as TV, STB (Set-top box), DVD (Digital Versatile Disk) player/recorder or BD player/recorder.

As described above, when a low potential defect problem of a device is analyzed, for example, a pixel value observation function will be sometimes needed. The pixel value observation function means the function to store a pixel value of a specified coordinate of a display image in a register, and to read out the pixel value by a CPU for analysis. One method to achieve this is to determine the coordinate while turning on/off a marker function (displaying a marker having a specified width in a specified coordinate) to allow a user to visually check which of the pixel value of a coordinate is detected, However, the size of the circuit increases to carry out the marker function,

To solve the problem stated above, the inventor has found an image processing device which enables to obtain a pixel value of a pixel in an objective position in an image (screen). That is, to visually recognize the objective position in the image, a color of a noticeable pixel whose pixel value is read out or an adjacent pixel adjacent to the noticeable pixel is changed. Hence, the position on the image of the pixel whose pixel value needs to be read out can be visually recognized, and the image processing result can be quickly checked.

### First Exemplary Embodiment

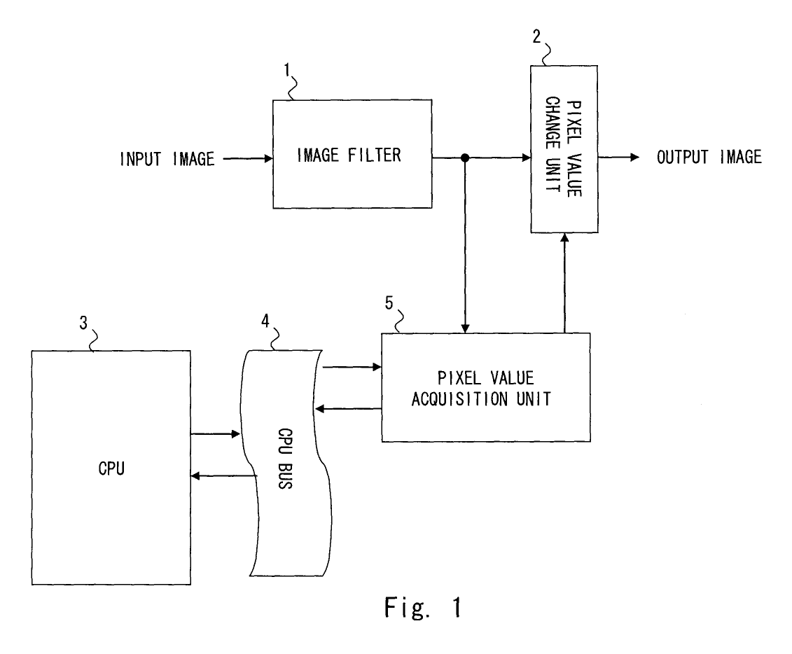

FIG. 1 is a view showing an image processing device of a first exemplary embodiment of the present invention. The image processing device of the first exemplary embodiment obtains a pixel value of a pixel in an objective position (hereinafter referred to as “target pixel”) on the image. This image processing device includes an image filter 1 which performs predetermined image processing an input image, a pixel value change unit 2 which changes a pixel value of a pixel in a desired position on an output image, a CPU 3, a CPU bus 4 and a pixel value acquisition unit 5. The pixel value acquisition unit 5 includes a pixel value register which obtains a pixel value of a target pixel on the image (output image) processed by the image filter 1 at a desired timing as a pixel value read out unit. The desired timing is from search start to search end when an objective position in the image processed by the image filter is searched by a target pixel. Further, the pixel value acquisition unit 5 cooperates with the CPU 3 and the CPU bus 4, and constitutes a coordinate specify unit which specifies a position of the target pixel whose pixel value is changed in an image. The image device can search an objective position on an output image of a target pixel by changing a coordinate of the target pixel by the coordinate specify unit.

The image filter 1 performs a filtering process for the purpose of sharpness, feathering, embossment, solarization, contour enhancement, and contour detection and so on. The image processing includes extraction of the specific area for specific processing instead of performing equal processing on a whole screen. In this case, a pixel value in such a specific area is obtained and pixel values before and after processing may sometimes be compared and analyzed. In such a case, in the first exemplary embodiment, a pixel value of a target pixel whose pixel value is obtained is changed. That is, since the color of the target pixel is changed an objective position can be searched while allowing a user to visually check the target pixel. In summary, the image processing device of the first exemplary embodiment enables to obtain a pixel value of a pixel in a desired position on an image. For example, by comparing the pixel values before and after processing, it can be tested whether or not the image processing is performed adequately.

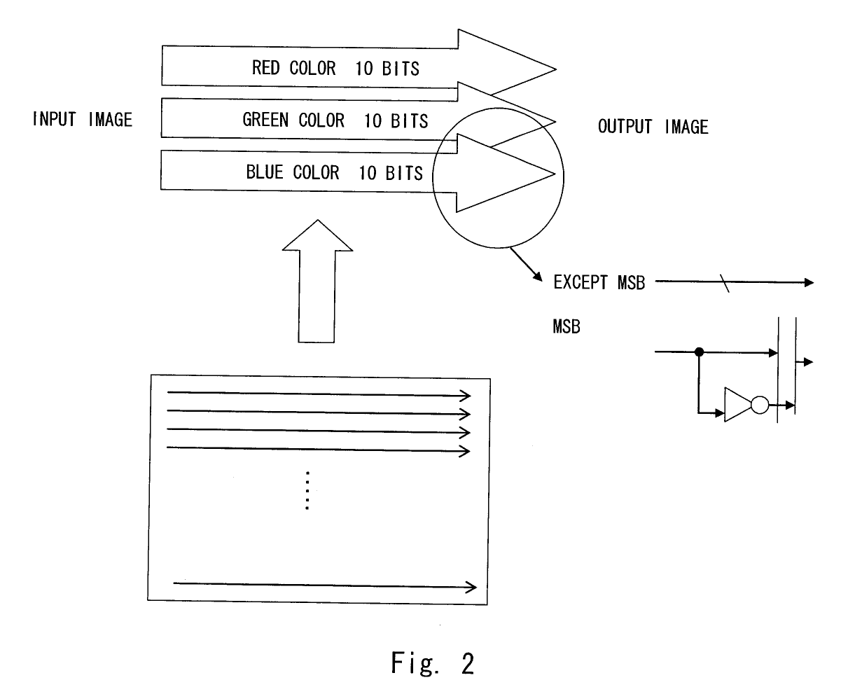

FIG. 2 is an explanation view showing a method of changing a pixel value. For example, description will be mode of a case where one pixel includes ten-bit data which forms red, ten-bit data which forms green, and ten-bit data which forms blue.

When the output image is displayed in a raster scan, pixel value for each row corresponding to a scan line is output from the image filter 1 and displayed. As shown in FIG. 2, in the raster scan, after the last position of each scan line, the scanning is moved to the next line (vertical scanning). By repeating such processing, one image is transferred and displayed, and the pixel value acquisition unit 5 stores these data output from the image filter 1 in a register at a desired timing. Meanwhile, the pixel value change unit 2 is provided before the output stage. The pixel value change unit 2 changes the pixel value of the target pixel by inverting MSB (Most Significant Bit) of the pixels of the output image, for example.

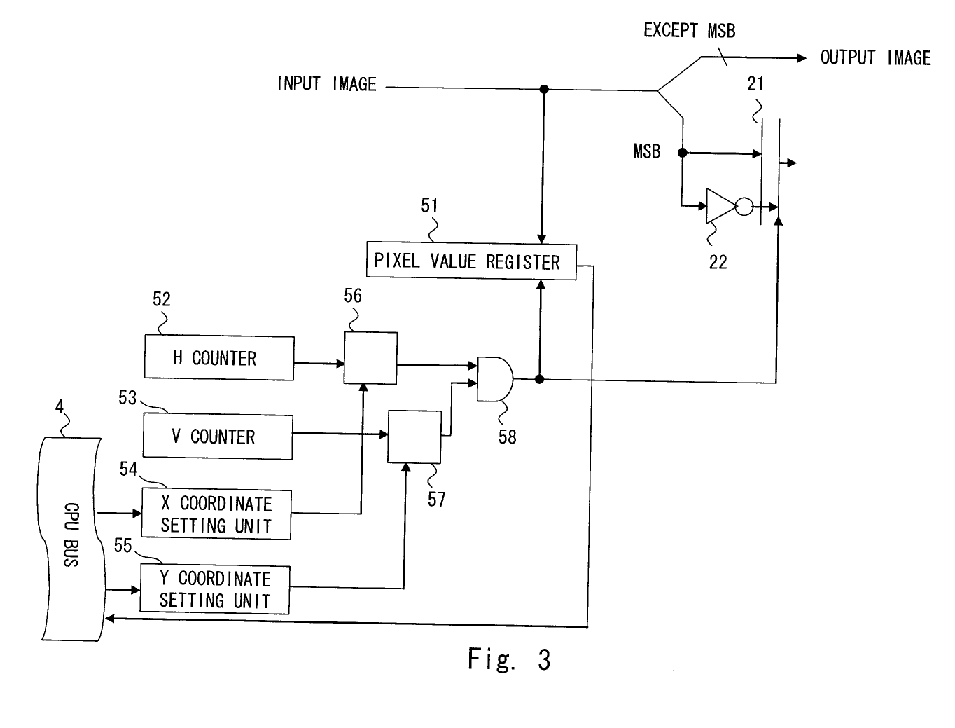

Hereinafter, the image processing device of the first exemplary embodiment will be described in detail. FIG. 3 is a circuit diagram showing the image processing device when the output image is displayed in the raster scan in more detail according to the first exemplary embodiment of the present invention. As shown in FIG. 3, the pixel value change unit 2 includes an inverter 22 to invert MSB of the pixel value and a selector 21 which selectively outputs inverted or non-inverted MSB. Data except MSB among image data which is subjected to the filter processing is output without being changed. MSB and data which is obtained by inverting MSB by the inverter 22 are input to the selector 21, and the selector 21 selects and outputs the inverted data only when the pixel value is changed. For example, assumed that MSB of ten-bit signal is replaced. In this case, if the value is 511, the resultant value becomes 1023 by inverting MSB.

The control signal of the selector 21 is output from the pixel value acquisition unit 5. The pixel value acquisition unit 5 includes a pixel value register 51, an H counter 52, a V counter 53, an X coordinate setting unit 54, a Y coordinate setting unit 55, match detection units 56, 57 and an AND circuit 58.

The pixel value register 51 receives an output of the image filter 1, and stores a desired pixel value based on an output of the AND circuit 58. That is, the pixel value register 51 receives a pixel value at a timing when the output of the AND circuit 58 is active.

The H counter 52 counts a pixel value of the image data in a horizontal direction, and the count value shows a position in a lateral direction of the display image which is being searched. The V counter 53 counts a pixel value of the image data in a vertical direction, and the count value shows a position in a longitudinal direction of the display image. The H counter 52 is cleared by HSYNC signal (Horizontal Synchronizing signal). The V counter 53 is cleared by VSYNC signal (Vertical Synchronizing signal).

The X coordinate setting unit 54 and the Y coordinate setting unit 55 set X coordinate and Y coordinate, respectively, by the CPU 3 through the CPU bus 4. When the count value of the H counter 52 matches to a setting value of the X coordinate setting unit 54, the match detection unit 56 outputs a matching signal into the AND circuit 58. When the count value of the V counter 53 matches to a setting value of the Y coordinate setting unit 55, the match detection unit 57 outputs a matching signal into the AND circuit 58.

When both of outputs of the match detection units 56 and 57 are high (output the matching signals), the AND circuit 58 outputs high level signal. Then, the pixel value register 51 receives the pixel value and the selector 21 selects an inverted signal. That is, after the pixel value register 51 receives the pixel value, the pixel value is inverted.

This changes the color of the pixel in a desired position set by the CPU on the display. A user can visually check if the pixel whose pixel value is obtained is in a desired position or not by seeing the display. For example, when the image processing is performed in a specific area on the display, a pixel value of a pixel in the specific area is sometimes desired to be obtained. In such a case, for example, first, X coordinate and Y coordinate of a target pixel are appropriately set, and then the color of the pixel is changed. If the position of the target pixel is deviated from the specific area which is desired to be obtained, X coordinate and Y coordinate are changed so that the target pixel is positioned in the specific area, and then the color of the target pixel is changed again and the position is checked again. Since the target pixel is visually recognized by changing the color of the target pixel, the target pixel can be moved to the desired position by using the target pixel. Hence, the pixel value of the objective position can be obtained. Note that, when the data of the coordinate of the objective position is desired to be obtained, the setting values of the X coordinate setting unit 54 and the Y coordinate setting unit 55 are read out when the target pixel is in the objective position. Therefore, it is possible to obtain the data of coordinate of the objective position in the display.

Furthermore, in the first exemplary embodiment, the color of the pixel value is changed by inverting the most significant bit MSB of the pixel value; however, the method of changing the color (changing the pixel value) is not limited to this. For example, all bits of the pixel value may be inverted. Assume that the pixel value is ten-bit. In this case, if the signal indicates 255, the resultant signal becomes 768 by inverting all bits.

Furthermore, a predetermined value may be added to the pixel value. For example, assume that the pixel value indicates 256. In this case, if the adding value is 256, the pixel value after adding processing becomes 512. Note that, the adding values can be set and changed by the CPU 3 by instruction of a user, for example. Furthermore, a predetermined value may be subtracted from the pixel value.

Furthermore, the pixel value can be shifted to right or left. For example, if the pixel value is shifted to right by one bit, the pixel value becomes one-half; if the pixel value is shifted two bits, the pixel value becomes one-quarter. If the pixel value is shifted to left by on bit, the pixel value becomes double; if the pixel value is shifted to left by two bits, the pixel value becomes quadruple.

Furthermore, the pixel value can be replaced with another value. In this case, the CPU 3 can set or change the pixel value according to user instruction.

### Second Exemplary Embodiment

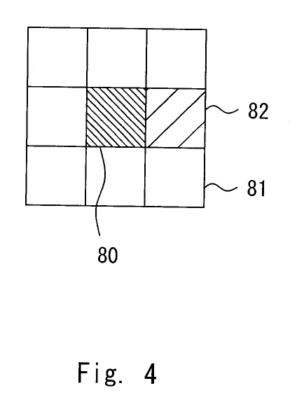

Next, a second exemplary embodiment will be described. In the first exemplary embodiment, the color of the target pixel whose pixel value is obtained is changed. However, in this exemplary embodiment, the color of the pixel adjacent on the right side of the target pixel will be changed. FIG. 4 is a view showing a target pixel and a noticeable pixel of a second exemplary embodiment of the present invention. Among eight adjacent pixels 81 that surround a target pixel 80, a pixel adjacent on the right side of the target pixel 80 is as assumed to be a noticeable pixel 82. In this exemplary embodiment, the pixel value of this noticeable pixel 82 will be changed.

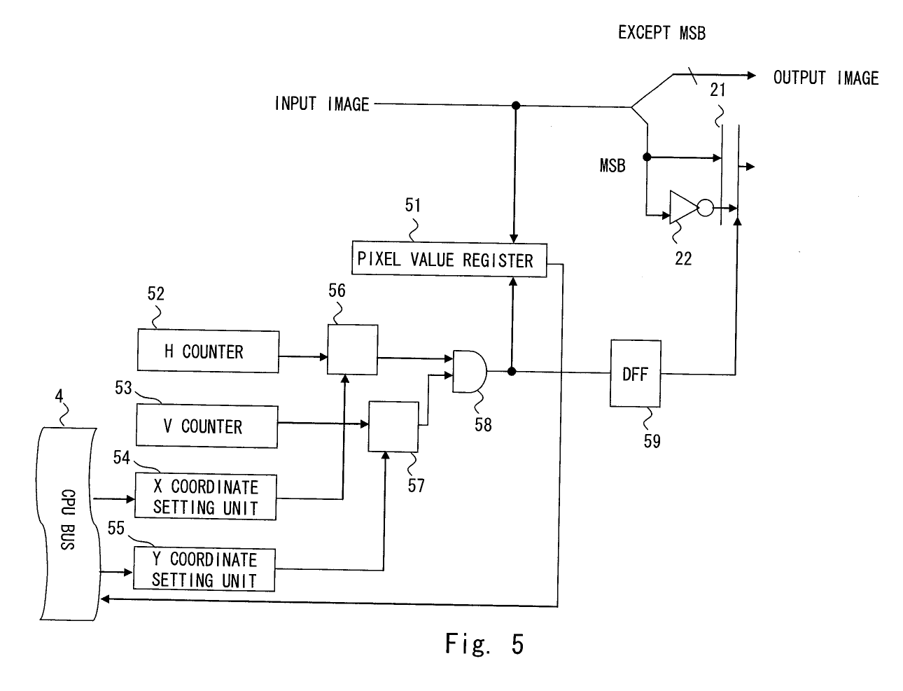

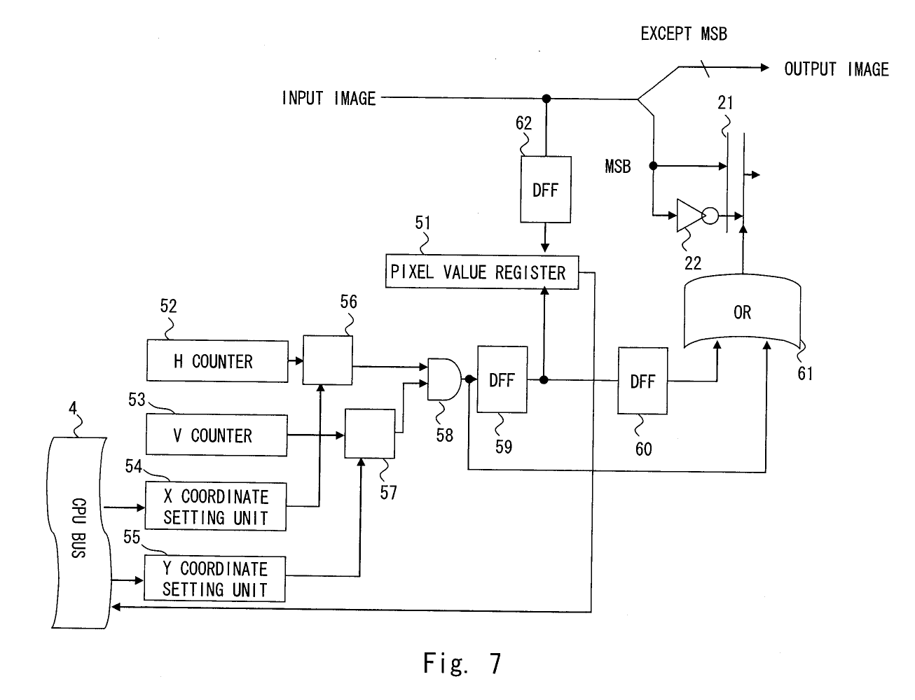

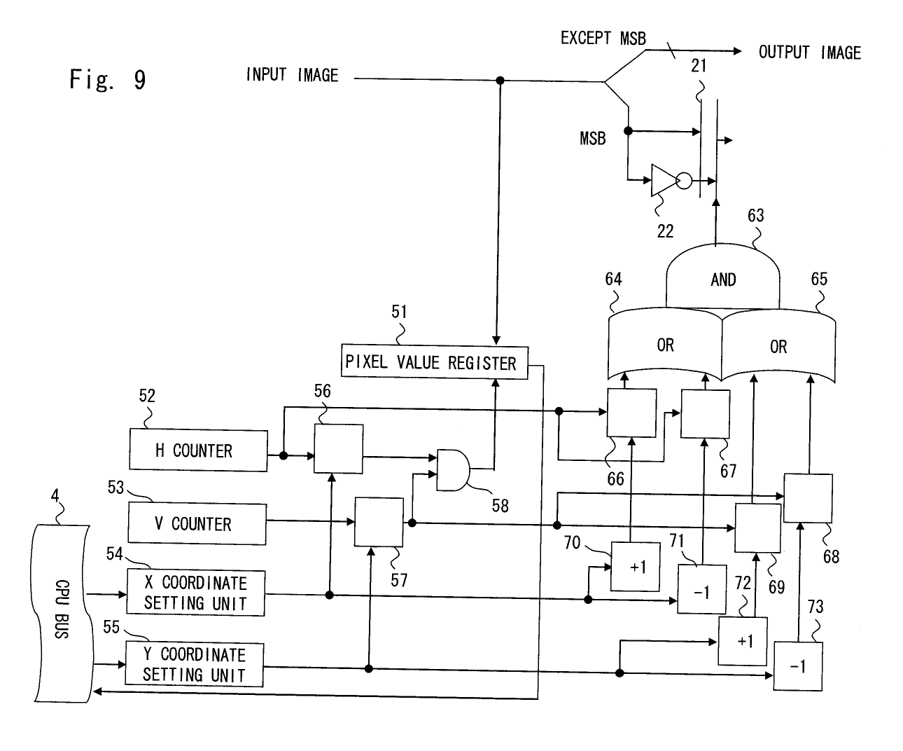

FIG. 5 is a circuit diagram showing an image processing device in detail of the second exemplary embodiment of the present invention. Here, description will be made of a case where an output image is displayed in a raster scan. Note that, in the second exemplary embodiment shown in FIG. 5 and other exemplary embodiments shown in FIG. 7 and FIG. 9, the same components as those in the first exemplary embodiment shown in FIG. 3 will be denoted by the same symbols and the detailed explanation will be omitted.

Since the image is displayed in the raster scan, an adjacent pixel (a noticeable pixel 82) adjacent on the right side of the target pixel which is specified by X coordinate and Y coordinate is output one clock after the pixel value of a target pixel is obtained by the pixel value register 51. Therefore, an output of the AND circuit 58 which instructs the pixel value register 51 to receive the pixel value is delayed by one clock, and the delay signal can be a selecting signal of the selector 21. Therefore, in the image processing device of the present exemplary embodiment, a flip flop (DFF) 59 is provided between the AND circuit 58 and the selector 21 to delay the output of the AND circuit 58 by one clock. This DFF 59 delays a signal which allows the pixel value register 51 to receive the pixel value by one clock, and MSB of the pixel value is inverted in response to the delay signal.

The present exemplary embodiment also achieves the same effect as the first exemplary embodiment. That is, when a user sets an appropriate coordinate, the pixel value of the target pixel is obtained and the color of the noticeable pixel adjacent on the right side of the target pixel is changed. Accordingly, the user can visually recognize which position the target pixel whose pixel value is obtained is located in the display. Therefore, the pixel value of the pixel which is in the objective position on the display can be extracted as the pixel value of the target pixel by using the noticeable pixel whose color is changed.

### Third Exemplary Embodiment

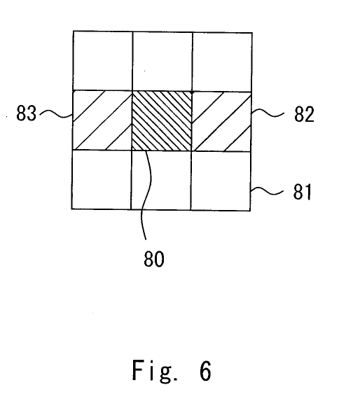

Next, a third exemplary embodiment will be explained. In the above second exemplary embodiment, the color of the pixel adjacent on the right side of the target pixel whose pixel value is obtained is changed. However, in the third exemplary embodiment, the colors of pixels adjacent on the right side and the left side of the target pixel will be changed. FIG. 6 is a view showing a target pixel and noticeable pixels of the third exemplary embodiment of the present invention. A pixel 82 adjacent on the right side and a pixel 83 adjacent on the left side among eight adjacent pixels 81 surrounding a target pixel 80 are assumed to be noticeable pixels. In the third exemplary embodiment, the pixel values of the noticeable pixels 82 and 83 will be changed.

FIG. 7 is a circuit diagram showing an image processing device in detail of the third exemplary embodiment of the present invention. Since the image is displayed in a raster scan, signals before and after the signal which instructs reception of the pixel value are used as signals that instruct color inversion. Therefore, a DFF 59 which delays an output of the AND circuit 58 by one clock and a DFF 60 which delays an output of the DFF 59 by another one clock are added. Furthermore, an OR circuit 61 which outputs logical OR of the output of the AND circuit 58 and the output of the DFF 60 is provided, and the output of the OR circuit is used as a control signal of the selector 21.

By the output of the AND circuit 58, the pixel value of the noticeable pixel 83 is changed; by the output of the DFF 59, the pixel value of the target pixel 80 is received by the pixel value register 51; by the output of the DFF 60, the pixel value of the noticeable pixel 82 is changed.

According to the third exemplary embodiment, the colors of the pixels adjacent on the right and the left sides of the target pixel 80 are changed. Hence, it is easier to visually recognize the noticeable pixels and the pixel position of the target pixel can be check more quickly.

### Fourth Exemplary Embodiment

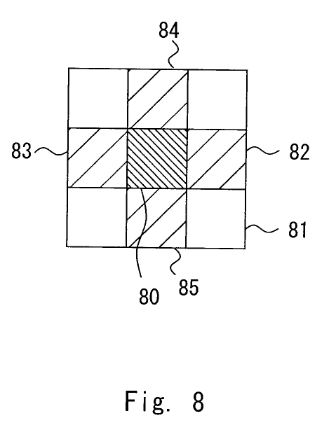

Next, a fourth exemplary embodiment will be explained. In the above third exemplary embodiment, the colors of the pixels adjacent on the right side and the left side of the target pixel are changed. In the fourth exemplary embodiment, the colors of four adjacent pixels adjacent to the right side, the left side, the upper side, and the lower side of the target pixel will be changed. FIG. 8 is a view showing a target pixel and noticeable pixels of the fourth exemplary embodiment of the present invention. A right side adjacent pixel 82, left side adjacent pixel 83, an upper side adjacent pixel 84, and a lower side adjacent pixel 85 among eight adjacent pixels surrounding the target pixel 80 whose pixel value is obtained are assumed to be the noticeable pixels. In this exemplary embodiment, the pixel values of these noticeable pixels 82 to 85 will be changed.

FIG. 9 is a circuit diagram showing an image processing device in detail of the forth exemplary embodiment of the present invention. In this exemplary embodiment, after the pixel value register 51 obtains the pixel value of the target pixel 80 which is specified by the X coordinate setting unit 54 and the Y coordinate setting unit 55, the colors of the four pixels of the right side, the left side, the upper side, and the lower side of the target pixel 80 will be changed. In the fourth exemplary embodiment, a signal (an output of the AND circuit 58) which allows the pixel value register 51 to receive the pixel value is not used as a signal (a control signal of the selector 21) which changes the colors of the pixel values. Instead, in the image processing device of the fourth exemplary embodiment, the coordinates of the right side, the left side, the upper side, and the lower side of the target pixel 80 which is specified by the X coordinate setting unit 54 and the Y coordinate setting unit 55 are calculated in advance, and MSB of the pixel value of the noticeable pixels is inverted by comparing the calculated value with the count values of the H counter 52 and the V counter 53. Further, the image processing device includes match detection circuits 66, 67, 68, and 69, an adder 70 which increments the setting value of the X coordinate setting unit 54, a subtracter 71 which decrements the setting value of the X coordinate setting unit 54, an adder 72 which increments the setting value of the Y coordinate setting unit 55, and a subtracter 73 which decrements the setting value of the Y coordinate setting unit 55. Furthermore, the image processing device includes an OR circuit 64 which outputs a logical OR of the match detection circuits 66 and 67, an OR circuit 65 which outputs a logical OR of the match detection circuits 68 and 69, and an AND circuit 63 which outputs a logical AND of the OR circuits 64 and 65.

In the fourth exemplary embodiment, the colors of the pixels of the right side, the left side, the upper side, and the lower side of the target pixel 80 are changed. Accordingly, it is easier to visually recognize the target pixel, and it is possible to check the pixel position of the target pixel more quickly.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

Further, the first to fourth exemplary embodiments can be combined as desirable by one of ordinary skill in the art.

Furthermore, for example, in the above exemplary embodiments, the data receiving device is explained as hardware. However, arbitrary processing may be achieved by executing a program by CPU (Central Processing Unit). The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Furthermore, in the above second to fourth exemplary embodiments, a part of pixels among the adjacent pixels 81 adjacent to the target pixel 80 is assumed to be noticeable pixels. However, pixel values of all adjacent pixels may be changed. Further, the pixel value of any pixel which surrounds the target pixel and can specify the target pixel may be changed.

What is claimed is:

1. An image processing device comprising:
a pixel value read out unit which reads out a pixel value of a target pixel;
a pixel value change unit which changes the pixel value of the target pixel; and
a coordinate specify unit which specifies a position of the target pixel in an image, the pixel value of the target pixel being changed.

2. An image processing device comprising:
a pixel value read out unit which reads out a pixel value of a target pixel;
a pixel value change unit which changes a pixel value of a noticeable pixel, the noticeable pixel being at least one pixel of adjacent pixels adjacent to the target pixel; and
a coordinate specify unit which specifies a position of the target pixel in an image, the target pixel being adjacent to the noticeable pixel included in the adjacent pixels, the pixel value of the noticeable pixel being changed.

3. The image processing device according to claim 1, wherein the pixel value change unit changes a pixel value of the target pixel or a noticeable pixel by inverting a most significant bit of the pixel value of the target pixel or the noticeable pixel, inverting all bits of the pixel value, adding or subtracting a predetermined value, shifting the pixel value in right or left by a predetermined bits, or replacing the pixel value with a predetermined value, the noticeable pixel being at least one pixel of adjacent pixels adjacent to the target pixel.

4. The image processing device according to claim 2, wherein the pixel value change unit changes the pixel value of the target pixel or the noticeable pixel by turning over a most significant bit of a pixel value of the target pixel or the noticeable pixel, turning over all bits of the pixel value, adding or subtracting predetermined value, sifting right or left by a predetermined bit of the pixel value, or replacing the pixel value with predetermined value.

5. An image processing device comprising:
an image filter which performs predetermined image processing to an input image;
a pixel value read our unit which reads out a pixel value of a target pixel at a desired timing, the desired timing being from search start to search end when an objective position in the image processed by the image filter is searched by a target pixel;
a pixel value change unit which changes the pixel value of the target pixel; and
a coordinate specify unit which specifies a position of the target pixel in an image, the pixel value of the target pixel being changed.

6. An image processing device comprising:
an image filter which performs predetermined image processing to an input image;
a pixel value read out unit which reads out a pixel value of a target pixel at a desired timing, the desired timing being from search start to search end when an objective position in the image processed by the image filter is searched by a noticeable pixel, the noticeable pixel being at least one pixel of adjacent pixels of the target pixel;
a pixel value change unit which changes a pixel value of the noticeable pixel; and
a coordinate specify unit which specifies a position of the target pixel in an image, the target pixel being adjacent to the noticeable pixel included in the adjacent pixel, the pixel value of the noticeable pixel being changed.

7. The image processing device according to claim 1, wherein the coordinate specify unit comprises:
a horizontal counter which counts X coordinate;
a vertical counter which counts Y coordinate;
an X coordinate store unit which sets an X coordinate value; and
a Y coordinate store unit which sets a Y coordinate value;
wherein the pixel value read out unit reads out the pixel value of the target pixel at a timing at which count values of the horizontal counter and the vertical counter match the X coordinate value and the Y coordinate value set in the X coordinate store unit and the Y coordinate store unit, respectively.

8. The image processing device according to claim 2 wherein, the coordinate specify unit comprises:
a horizontal counter which counts X coordinate;
a vertical counter which counts Y coordinate;
an X coordinate store unit which is set to an X coordinate value; and
a Y coordinate store unit which is set to a Y coordinate value;
wherein the pixel value read out unit reads out the pixel value of the target pixel in a timing at which count values of the horizontal counter and the vertical counter correspond to the X coordinate value and the Y coordinate value set in the X coordinate store unit and the Y coordinate store unit respectively.

9. The image processing device according to claim 5 wherein, the coordinate specify unit comprises:
a horizontal counter which counts X coordinate;
a vertical counter which counts Y coordinate;
an X coordinate store unit which is set to an X coordinate value; and
a Y coordinate store unit which is set to a Y coordinate value;
wherein the pixel value read out unit reads out the pixel value of the target pixel in a timing at which count values of the horizontal counter and the vertical counter correspond to the X coordinate value and the Y coordinate value set in the X coordinate store unit and the Y coordinate store unit respectively.

10. The image processing device according to claim 6 wherein, the coordinate specify unit comprises:
a horizontal counter which counts X coordinate;
a vertical counter which counts Y coordinate;
an X coordinate store unit which is set to an X coordinate value; and
a Y coordinate store unit which is set to a Y coordinate value;
wherein the pixel value read out unit reads out the pixel value of the target pixel in a timing at which count values of the horizontal counter and the vertical counter correspond to the X coordinate value and the Y coordinate value set in the X coordinate store unit and the Y coordinate store unit respectively.

11. An image processing method comprising:
reading out a pixel value of a target pixel;
changing the pixel value of the target pixel; and
specifying a position of the target pixel in an image and checking the position of the target pixel in the image to acquire the pixel value of the target pixel in an objective position, the pixel value of the target pixel being changed.

12. An image processing method comprising:
reading out a pixel value of a target pixel;
changing a pixel value of a noticeable pixel, the noticeable pixel being at least one pixel of adjacent pixels adjacent to the target pixel; and
specifying a position of the target pixel in an image and checking a position of the noticeable pixel in the image to acquire the pixel value of the target pixel in an objective position, the target pixel being adjacent to the noticeable pixel included in the adjacent pixels, the pixel value of the noticeable pixel being changed.
